(19) United States
(12) Patent Application Publication
(10) Pub. No.: US 2005/0095325 A1
(43) Pub. Date: May 5, 2005

(54) Flexible wrist holder with an attachable cover for storing and protecting candy

(76) Inventor: Kendall Rycroft, Navarre, FL (US)

Correspondence Address: BIRCH STEWART KOLASCH & BIRCH, PO BOX 747, FALLS CHURCH, VA, 22040-0747, US

(21) Appl. No.: 10/697,330

(22) Filed: Oct. 31, 2003

(51) Int. Cl. A23G 1/00

(52) U.S. Cl. 426/132

(57) ABSTRACT

The present invention is directed to a flexible wrist bracelet that has a pivotal receiver for a stick of a lollipop and a cover for the entire lollipop that lays against the arm of the user or wearer. The cover for the lollipop can be spring-loaded and have an actuating member to swing the lollipop up for accessibility to an edible end. In the other embodiment, the flexible wrist bracelet gently encompasses the wrist and a securing member receives a piece of candy and securely holds the candy in an edible position, and there is a cap that is securely attached to the flexible wrist bracelet and covers the securing member. The candy is completely covered in the securing member and protected from dirt and debris while consumption of the candy is halted.

### BACKGROUND OF THE INVENTION

1. Field of the Invention

The present invention relates to hard candy, lollipops or suckers, and soft gummy candy. More specifically, the present invention relates to a flexible wrist holder with an attachable cover for storing and protecting candy when not in use.

There have been many devices made that have attempted to dispense candy wherein the candy is hard such as a lollipop, sucker or other lickable type candy. Some of these devices provide attaching covers. Other such devices include means to attach the candy to a part of the body such as a finger, hand or wrist. Yet, none of the prior art devices include both a protector of the candy and an attachment to a body part.

In U.S. Patent Application Publication US 2002/0090423 to Shecter, a candy lollipop head is attached to a wristband, which is reusable. As shown in each of the figures, the candy is attached to a removable bracket and to a post. However, the patent does not teach covering the entire lollipop or candy when not in use.

U.S. Pat. No. 6,120,816 to Chan is a lollipop with a pivot holder. This particular device does not fit on the wrist. Similarly, U.S. Pat. No. 5,993,870 to Hoeting et al. is a holder and coating device for lollipop or ice cream treats. This patent lacks an attachment to the wrist, although it does have a cover, which is removable to protect the candy when not being devoured.

Some patents recognize the need for a covering, such as U.S. Pat. No. 5,955,099 to White. This patent is directed to a lollipop storage assembly that also has a removable cover for protecting the lollipop. However, this patent does not attach to the wrist and thus is easily misplaced or lost.

Therefore, a need exists for a simple device that can store the candy safely, cleanly and keep it generally protected while still being attached to the user and consumption is halted.

### SUMMARY OF THE INVENTION

The present invention provides an entertaining candy wrist holder that includes a flexible wrist bracelet for gently encompassing a wrist. There is a securing member to receive a candy and securely hold the candy in an edible position. Additionally, the bracelet includes a cap that is securely attached and covers the securing member so that the candy is completely covered and protected from dirt and debris while consumption of the candy is halted.

Accordingly, it is an object of the invention to provide a candy wrist holder wherein the wrist holder is fabricated from plastic.

A further object of the invention is to provide a candy wrist holder that holds candy that is edible and gummy soft.

A still further object of the invention is to provide a candy wrist holder that holds candy that is edible and hard.

Another object of the invention is to provide a candy cover, the candy cover having a size suitable to removably fit over the candy, and further having means to removably attach to the wrist band such that when the cover is attached, the candy is enclosed, and when the cover is detached the cover is secure to the wrist holder.

An object of the invention is to provide the candy wrist holder with a generally circular, ring receiving housing formed of a light-weight, semi-rigid material. The housing includes a base having a central cavity mounting an electrical light source and supporting electrical power source. A circular side wall extends from the base and terminates in an annular surface to define a ring receiving recess, and plural radially and upwardly extending, light transmitting, fiber optic filaments segments within the sidewall, where a first end of each segment is in close proximity to the light source, and the opposite end of each segment terminates along the annular surface.

It is an object of the invention to provide a storage and access flexible wrist bracelet for a lollipop or confectionary-like candy with a stick wherein the flexible bracelet includes a pivotal receiver for the stick of the lollipop and a cover for covering the entire lollipop as the lollipop lays against an arm of a user. The receiver for the lollipop has a spring-loaded actuating means for swinging the lollipop up during accessibility for consumption of the lollipop.

A further object of the invention is to have the storage and access flexible wrist bracelet fabricated from plastic.

A still further object of the invention is to provide the storage and access flexible wrist bracelet with candy that is edible and gummy soft.

Another object of the invention is to provide the storage and access flexible wrist bracelet with candy that is edible and hard.

An object of the invention is to provide the storage and access flexible wrist bracelet with the candy cover having a size suitable to removably fit over the candy, and further having means to removably attach to the wrist band such that when the cover is attached, the candy is enclosed and when the cover is detached, the cover is secure to the wrist bracelet.

Another object of the invention is to provide the storage and access flexible wrist bracelet with a generally circular, ring receiving housing formed of a light-weight, semi-rigid material, the housing including a base having a central cavity mounting an electrical light source and supporting electrical power source, a circular side wall extending from the base and terminating in an annular surface to define a ring receiving recess, and plural radially and upwardly extending, light transmitting, fiber optic filaments segments within the sidewall, where a first end of each segment is in close proximity to the light source, and the opposite end of each segment terminates along said annular surface.

### BRIEF DESCRIPTION OF THE DRAWINGS

A preferred structural embodiment and preferred subcomponents of this invention are disclosed in the accompanying drawings in which:

FIG. 1 is a top view of a preferred embodiment of the invention which illustrates a wrist pop with a single lollipop candy mounted on the top of a disposable bracket attached to a reusable wrist band;

FIG. 2 is a perspective view of an alternative preferred embodiment of the invention that illustrates the storage and access flexible wrist bracelet;

FIG. 3 is an exploded perspective, with parts in phantom, to show internal details, a pair of battery packs or casements poised for entry into the assembly housing, and a reflector plate;

FIG. 4 is a bottom perspective view, with parts in phantom, showing different internal details of the assembly of the invention;

FIG. 5 is an enlarged top view showing the motor for driving a color transmitting wheel of the present invention; and

FIG. 6 is an exploded perspective view showing an encasement assembly for the color transmitting wheel for use in the present invention.

### DESCRIPTION OF THE INVENTION

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

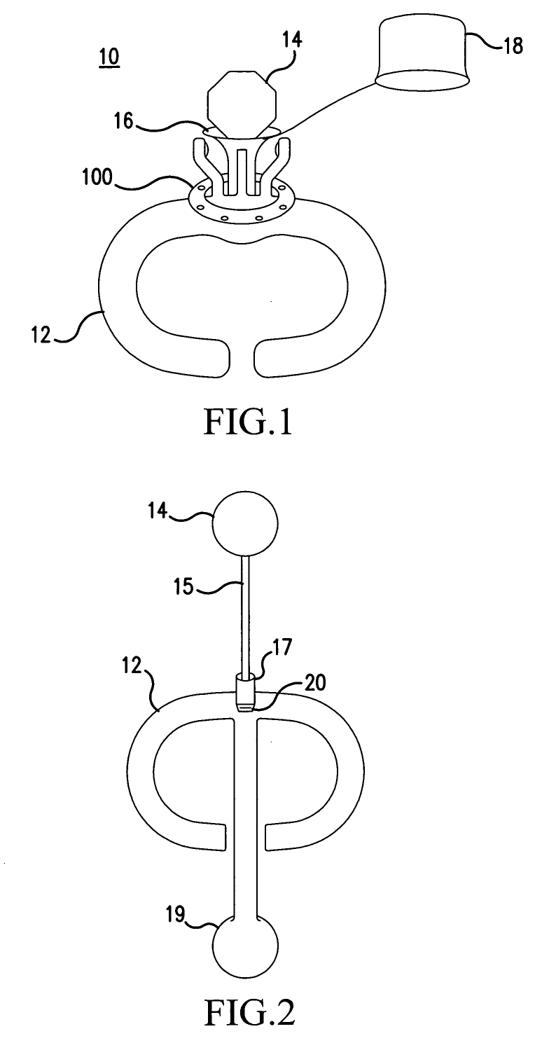

Referring to FIG. 1, this figure shows a perspective view of a preferred embodiment of the candy wrist holder 10. In this embodiment, the candy wrist holder 10 is shaped in a form similar to that of a conventional jewelry bracelet so that a part that is generally indicated as a flexible wrist bracelet 12 is merely slipped or slid over a child's hand and placed on the wrist area. In fact, the flexible wrist bracelet 12 gently encompasses the child's wrist, because the wrist bracelet 12 is fabricated from plastic. A candy 14 is shown attached to a securing member 16 that receives the candy 14 and securely holds the candy 14 in an edible position. The securing member 16, in turn, is attached to the flexible wrist bracelet 12.

A removable cover 18 is inserted over the top of the candy 14. The removable cover 18 would preferably be fit onto the securing member 16 when the candy 14 is not being consumed. The cover 18 provides an advantage in that it helps keep the candy 14 clean while the child is playing. The candy cover 18 had a size suitable to removably fit over the candy 14, and further has means to removably attach to the wrist holder 10 such that when the cover 18 is attached, the candy 14 is enclosed, and when the cover 18 is detached the cover 14 is secured to the wrist holder 10. Accordingly, the cover or cap 18 securely attaches to the flexible wrist bracelet 12 and covers the securing member 16 so that the candy 14 is completely covered in the securing member 16 and protected from dirt and debris while consumption of the candy 14 is halted.

Those skilled in the art will recognize that the removable cover 18 can be attached via a pressure fit, can be threaded, or can be hingedly attached. Also, the candy 14 can be edible and gummy soft, such as a gumdrop. Alternatively, the candy 14 can be edible and hard.

Another embodiment contemplated is shown in FIG. 2. Here, a storage and access flexible wrist bracelet 12 for a lollipop or confectionary-like candy 14 with a stick 15 is shown. The flexible bracelet 12 comprises a pivotal receiver 17 for the stick 15 of the lollipop 12 and a cover 19 for covering the entire lollipop as the lollipop lays against an arm of a user. The receiver 17 for the lollipop has a spring-loaded actuating means 20 for swinging the lollipop 12 up during accessibility for consumption of the lollipop 12.

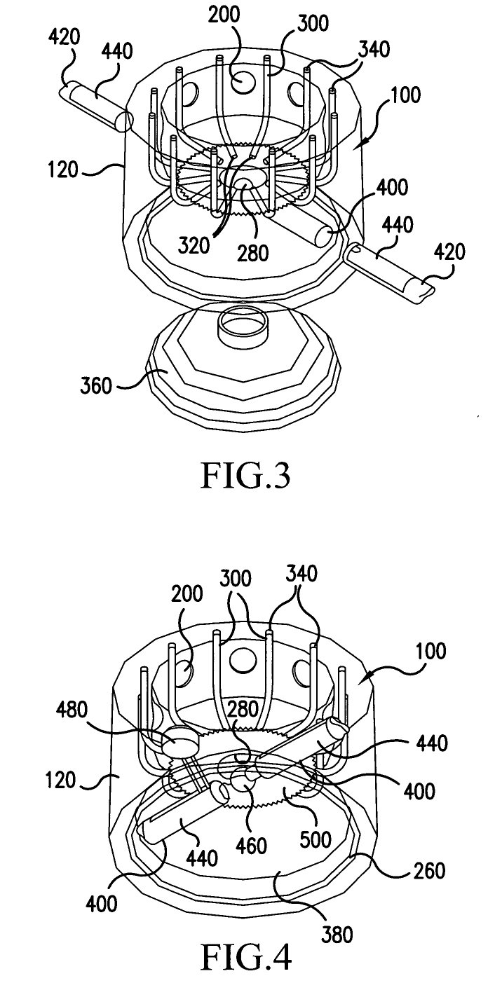

Referring now to FIGS. 1 and 3, the candy wrist holder 10 further includes a generally circular, ring receiving housing 100 formed of a light-weight, semi-rigid material. The housing 100 includes a base having a central cavity for mounting an electrical light source and supporting electrical power source. A circular side wall 120 extends from the base and terminates in an annular surface to define a ring receiving recess. There are plural radially and upwardly extending, light transmitting, fiber optic filament segments 300 within the sidewall 120. A first end 320 of each segment 300 is in close proximity to the light source, and the opposite end 340 of each segment 300 terminates along the annular surface.

As best seen in FIG. 3, the respective recesses 180, 240 are joined by a concentric, axially elongated opening 200. The housing 100 further features a plurality of radially and downwardly extending, light transmitting, fiber optic segments 300 within the sidewall 120, where the first ends 320 thereof open in proximity to the intersection between the upper recess 100 and the opening 200, with the opposite ends 340 extending to at least the annular surface 160. If desired, the opposite ends of the respective segments 300 may extend slightly above the surface 160.

Shown below the housing 100 is a circular, concave reflector member 360, preferably with a reflective coating on the inner surface 380 (FIG. 4), that is sized to snap fit into the first annular groove 260. The housing 100 further features a pair of aligned lateral channels 400 for slidably receiving a battery pack, or casement 420, 420′ which in turn receive removable batteries 440, 440′. As more clearer illustrated in FIG. 4, battery 440 is intended to power a light source, or bulb 460, while battery 440′ is intended to power a small motor 480, the function of which will be described later.

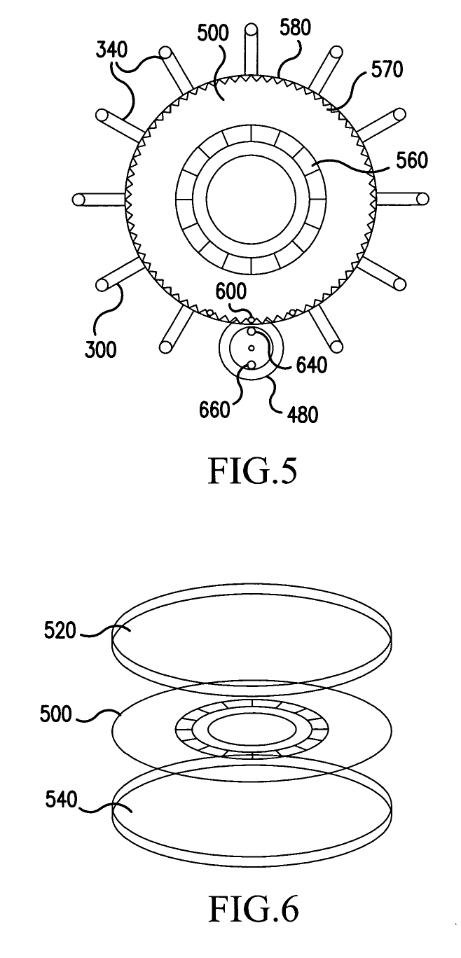

Since a feature of the invention is to provide changing or flashing colors that pass through the respective segments 300, means have been provided by a movable wheel 500, see FIGS. 4-6. The movable wheel is preferably encased in a sealed, liquid environment by transparent, engaging encasement members 520, 540, see FIG. 6. As best seen in FIG. 5, the movable wheel features a continuous, opaque color segments 560, where the respective colors are selected from those of a rainbow, for example. That is, as the wheel 500 moves relative to the fiber optic segments 300, where the wheel is positioned in proximity to the segment ends 320, light from the bulb 460 is filtered by the different colors.

Returning to the wheel construction, the periphery 570 thereof preferably is saw-toothed 580 to minimize rotating contact within the joined encasement members 520, 540. Additionally, in close proximity to the periphery 570, a series of magnets 600, with alternating polarity, are provided, see FIG. 5. To power the wheel 500, a small motor 480, featuring a pair of opposite poled magnets 640(+) and 660(-), is positioned adjacent the wheel 500. In a non-moving mode, the magnet on the wheel is opposite in polarity to that of the motor magnet. However, as the motor 480 begins to rotate, the polarity of the motor magnet will repel the same polar magnet of the wheel causing the wheel 500 to move. Whether the wheel moves back and forth, or incrementally in a single direction, different colored lights will be transmitted through the respective fiber optic segments 300.

The foregoing is considered as illustrative only of the principles of the invention. Further, since numerous modifications and changes will readily occur to those skilled in the art, it is not desired to limit the invention to the exact construction and operation shown and described, and, accordingly, all suitable modifications and equivalents may be resorted to, falling within the scope of the invention.

1. A candy wrist holder, comprising:
a flexible wrist bracelet for gently encompassing a wrist;
securing member receiving a candy and securely holding the candy in an edible position; and
a cap securely attached to said flexible wrist bracelet and covering said securing member so that the candy being completely covered in said securing member and protected from dirt and debris while consumption of the candy being halted.

2. The candy wrist holder, as in claim 1, wherein the wrist holder is fabricated from plastic.

3. The candy wrist holder, as in claim 2, wherein the candy is edible and gummy soft.

4. The candy wrist holder, as in claim 2, wherein the candy is edible and hard.

5. The candy wrist holder, as in claim 1, wherein said cap includes a candy cover, the candy cover having a size suitable to removably fit over the candy, and further having means to removably attach to the wrist band such that when the cover is attached, the candy is enclosed, and when the cover is detached the cover is secured to the wrist holder.

6. The candy wrist holder, as in claim 1, further comprising a generally circular, ring receiving housing formed of a light-weight, semi-rigid material, said housing including a base having a central cavity mounting an electrical light source and supporting electrical power source, a circular side wall extending from said base and terminating in an annular surface to define a ring receiving recess, and plural radially and upwardly extending, light transmitting, fiber optic filaments segments within said sidewall, where a first end of each said segment is in close proximity to said light source, and the opposite end of each said segment terminates along said annular surface.

7. A storage and access flexible wrist bracelet for a lollipop or confectionary-like candy with a stick, said flexible bracelet comprises a pivotal receiver for the stick of the lollipop and a cover for covering the entire lollipop as the lollipop lays against an arm of a user, said receiver for the lollipop having a spring-loaded actuating means for swinging the lollipop up during accessibility for consumption of the lollipop.

8. The storage and access flexible wrist bracelet, as in claim 7, wherein the wrist bracelet is fabricated from plastic.

9. The storage and access flexible wrist bracelet, as in claim 7, wherein the candy is edible and gummy soft.

10. The storage and access flexible wrist bracelet, as in claim 7, wherein the candy is edible and hard.

11. The storage and access flexible wrist bracelet, as in claim 7, wherein said cover includes a candy cap, the candy cap having a size suitable to removably fit over the candy, and further having means to removably attach to the wrist band such that when the cap is attached, the candy is enclosed and when the cap is detached, the cap is secured to the wrist bracelet.

12. The candy wrist holder, as in claim 7, further comprising a generally circular, ring receiving housing formed of a light-weight, semi-rigid material, said housing including a base having a central cavity mounting an electrical light source and supporting electrical power source, a circular side wall extending from said base and terminating in an annular surface to define a ring receiving recess, and plural radially and upwardly extending, light transmitting, fiber optic filaments segments within said sidewall, where a first end of each said segment is in close proximity to said light source, and the opposite end of each said segment terminates along said annular surface.
